(19) United States
(12) Patent Application Publication
(10) Pub. No.: US 2021/0016515 A1
(43) Pub. Date: Jan. 21, 2021

(54) JOINING OF FOILS IN PRECISE REGISTER

(71) Applicant: Bayer Aktiengesellschaft, Leverkusen (DE)

(72) Inventor: Christine ORO SAAVEDRA, Bergisch Gladbach (DE)

(21) Appl. No.: 16/320,173

(22) PCT Filed: Jul. 20, 2017
(86) PCT No.: PCT/EP2017/068362

§ 371 Date: Jan. 24, 2019

(30) Foreign Application Priority Data
Jul. 26, 2016 (EP) 16181278.9

(51) Int. Cl. B29C 65/18

(52) U.S. Cl. CPC B29C 65/18

(57) ABSTRACT

The present invention concerns the adjustment of positions of foils in relation to one another and with the joining of the foils in precise register to give a foil composite. The present invention provides a process for the production of a foil composite comprising at least two foils arranged in relation to one another in a defined manner in the foil composite, and also a system for the production of a foil composite of this type.

The present invention is concerned with the adjustment of positions of foils in relation to one another and with the joining of the foils in precise register to give a foil composite. The present invention provides a process for the production of a foil composite comprising at least two foils arranged in relation to one another in a defined manner in the foil composite, and also a system for the production of a foil composite of this type.

Foil-composite systems are encountered in many different ways in everyday life. One example of a foil composite is provided by a blister pack.

Blister packaging is preferred packaging for medicament portions such as tablets and capsules. The tablets or capsules in a blister pack are present in an arrangement made of individual depressions (blisters) in a plastics foil or aluminium foil. There is usually an aluminium foil sealing the blisters. The medicament portions can be removed individually by compressing the blisters and thus forcing the tablets through the aluminium foil. Within the sealed blisters, the tablets are protected from contamination and from atmospheric moisture.

The prior art contains many descriptions of blister packs, devices for production thereof, and also devices for the packaging of medicament portions in blister packaging (see, for example, U.S. Pat. No. 4,384,649 A, GB 2184086 A, EP 2272763 A1, EP 0849055 A1, EP 0257990 A2, EP 0210823 A1, DE 3803979 A1, CN 203003955 U).

Machine-production of blister packs comprises, in a first step, introducing blisters into a first foil (blister foil), charging products (e.g. tablets) to the blisters in a second step, and use of a second foil (sealable foil) to seal the blisters in a third step.

The blister foil and the sealable foil usually take the form of a roll or of sheets. There is usually a fourth step: the punching-out of individual blister packs from the foil composite. The laid-open specification EP 0210823 A1 reveals by way of example a device which can join a blister foil and sealable foil in roll form.

The sealable foil has usually been printed. The printing of the sealable foil can take place before it is brought together with the blister foil or thereafter. The printing of the sealable foil usually takes place before blister foil and sealable foil are brought together.

There are blister packs in which the information printed on the sealable foil must have a defined arrangement in relation to the blisters.

By way of example, the print on some medicament blisters has the days of the week in abbreviated form (Mo, Tu, We, Th, Fr, Sa, Su) on the sealable foil directly above the blisters, in order that the patient knows which tablet has to be removed from the blister pack on which day.

In order to ensure a defined arrangement of the print and the blisters in relation to one another, blister foil and printed sealable foil must be mutually superposed in appropriate manner before they are joined.

This arrangement of the sealable foil in relation to the blister foil is achieved manually, and is time-consuming.

EP 2860119 A1 describes a device for the joining of at least one portion of the outer foil to a portion of the base foil to give a foil composite (also termed sealing device), with incorporated detection equipment. Before each unit—moulding units, sealing unit and cutting unit—there is detection equipment positioned, taking the form of a camera or of a printed-mark sensor in the sealing equipment; before each processing step, it determines the position of a marking on the lower and/or upper foil of the packaging, and passes this onwards to a control unit. The second set of detection equipment for the marking of the lower foil is used before the sealing unit for the exact positioning of a second moulding unit, in order that the cover can be brought together in the sealing unit in the precise manner required with its associated tray, the position of which has been detected by way of the marking. The solution presented leads to an improvement of the appearance of the packaging through on-line regulation of the advancement steps, regulation of a stretching device and/or positioning of moulding units movable by means of motors, and also cutting unit. No detection device is used for the monitoring of the finished pack.

The above solution requires complicated provision of appropriate detection equipment to the sealing device before each unit; the quality of the finished sealed product is not determined.

Starting from the prior art described, a person skilled in the art is confronted with the technical problem, in the production of a foil composite, of incurring only low sensor costs in arranging two foils in relation to one another in the device for the joining of at least one portion of the outer foil to one portion of the base foil to give a foil composite.

The said problem is solved via the subject matter of independent claims 1, 8 and 9. Preferred embodiments are found in the dependent claims, and also in the description below.

The invention firstly provides a process for the production of a foil composite comprising at least one base foil and one outer foil, where the outer foil has elements that are to have a defined intended position in relation to the elements of the base foil.
where a machine using a device places at least a portion of the outer foil onto a portion of the base foil,
and the portions, placed together, of the outer foil and of the base foil are joined to give a foil composite,
characterized in that an actual position is obtained by using optical recording equipment to determine the position of the outer-foil elements in relation to the base foil elements in the foil composite,
the actual position is compared with the intended position in order to determine the deviation of the actual position from the intended position,
machine parameters are determined on the basis of the deviation of the actual position from the intended position,
the machine parameters are transferred to the device, and
the device accepts the machine parameters and thus adjusts the positions of the outer foil and of the base foil in relation to one another in a manner such that during the further joining of outer foil and base foil the position of the outer-foil elements in relation to the base-foil elements corresponds to the intended position.

In a preferred embodiment of the process, the optical recording equipment determines the actual position in the form of a depiction at least of a region of the foil composite produced.

It is preferable that the intended position has been stored in the form of a depiction at least of a region of the foil composite produced, and the actual position is the depiction at least of that region of the foil composite produced that has been stored for the definition of the intended position.

The present invention further provides a system comprising
an outer foil which comprises outer-foil elements,
a base foil which comprises base-foil elements,
a device for the joining at least of a portion of the outer foil to a portion of the base foil to give a foil composite in a manner such that the outer-foil elements in the foil composite are present in a defined intended position in relation to the base-foil elements, and
optical recording equipment for the optical detection of the actual position of the outer-foil elements in relation to the position of the base-foil elements in the foil composite, where detection capability covers at least that region of the produced foil composite that has been stored for the definition of the intended position,
a calculation unit for the determination of the deviation of actual position from intended position
a calculation unit for the determination of machine parameters based on the deviation of actual position from intended position, where the machine parameters provide information as to how the device must arrange the outer foil and the base foil in relation to one another in order that the actual position corresponds to the intended position.

Typically, the intended position has been stored in a memory. This data memory can be an element of the optical recording device and/or an element of the calculation unit for the determination of the deviation of actual position from intended position; the calculation unit for the determination of the deviation of actual position from intended position can obtain information from the data memory by way of communication elements.

The term “system component” is used for the following, individually or in combination: the device for the joining of at least one portion of the outer foil to one portion of the base foil to give a foil composite, the optical recording equipment for the optical detection of the actual position of the outer-foil elements in relation to the position of the base-foil elements in the foil composite, a calculation unit for the determination of the deviation of actual position from intended position, a calculation unit for the determination of machine parameters on the basis of the deviation of actual position from intended position, and the database for the storage of the depiction of the intended position.

By virtue of the definition of a region of the resultant foil composite as intended position, there is no essential requirement for fixed installation and precise positioning of the optical recording equipment for the optical detection of the actual position of the outer-foil elements in relation to the position of the base-foil elements in the foil composite in the device for the joining of at least one portion of the outer foil to at least one portion of the base foil to give a foil composite.

Because a depiction of the region is used, it is particularly easy to achieve a definition of the intended position: an image of the intended position is recorded and stored in the data memory, and the system is ready for use.

In a preferred embodiment of the system, the optical recording equipment for the optical detection of the actual position of the outer-foil elements in relation to the position of the base-foil elements in the foil composite has been designed as mobile device. The calculation unit for the determination of the deviation of actual position from intended position, and optionally the calculation unit for the determination of machine parameters on the basis of the deviation of actual position from intended position, can be integrated in the said mobile device. It is also possible to connect the mobile device to one or more of the other system components by way of communication systems for the transfer of information between the system components.

The mobile device can be used with any device for the joining of at least one portion of the outer foil to one portion of the base foil to give a foil composite (sealing device). If the intention is to manufacture different packaging in the said sealing device, a depiction of the intended position of the different foil composite is stored in the database and is defined as, and retrieved as, intended position for the calculation unit for the determination of the deviation of actual position from intended position.

The invention is described in more detail without any division within the subject matter of the invention (process and system). The explanations below are intended to be applicable analogously to all of the subject matter of the invention, in either context (process or system).

In the invention, an outer foil and a base foil are firstly joined to give a foil composite (satisfactorily) without regard to the position of the outer-foil elements in relation to the position of the base-foil elements. The actual position of the outer-foil elements in relation to the position of the base-foil elements is then determined optically. The actual position and the intended position are used to calculate the deviation of the actual position from the intended position. Finally, machine parameters are calculated from the deviation and transferred to the device; the device can use these to adjust the position of the outer foil and of the base foil in relation to one another in a manner such that during further joining of base foil and outer foil to give a foil composite the outer-foil elements are in spatially defined relation to the base-foil elements.

The term “foil” means a flexible and sheet-like structure.

The term “sheet-like” means that the dimension (known as height or thickness) of the foil in one spatial direction is substantially smaller (at least by a factor of 10, preferably at least by a factor of 50) than the dimensions in the other spatial directions (length, width). The term “flexible” means that the foil can undergo a certain degree of bending without any resultant irreversible damage. By way of example, a foil can be wound onto a cylindrical body and then unwound without exhibiting any significant resultant adverse effects. Typical examples of foils are the freshness-retention foils and aluminium foils known from household use. Another example of a foil is the photographic film previously used in analogue cameras.

The outer foil and the base foil are foils. The term “foil” here does not imply a unitary material. For the purposes of the present invention, a foil can by way of example also be a foil composite. In a foil composite, a plurality of (at least two) foils have been joined to give a single entity. Coated foils are also foils for the purposes of the present invention. By way of example, there are many packaging foils coated with aluminium in order to increase the barrier property of the foil in respect of air and/or moisture, or in order to reduce permeability to light.

There can moreover be blisters/depressions introduced into the outer foil and/or into the base foil in order to receive products (preferably tablets or capsules).

The outer foil and/or the base foil can moreover have been printed, and can have punched regions, notched regions, and also perforations.

The outer foil and/or the base foil usually consist(s) at least to some extent of a polymer.

Outer foil and/or base foil can take the form of a roll or the form of sheets.

They preferably take the form of rolls.

In a preferred embodiment, the outer foil and the base foil are components for the production of a blister pack for medicament portions (e.g. tablets or capsules).

It is therefore possible by way of example that the base foil is a blister foil. There are therefore depressions introduced into the foil in order to receive products (medicament portions). The outer foil can then be the sealable foil for the sealing of the depressions of the blister foil. However, it is also conceivable that the base foil is the sealable foil of a blister pack, while the outer foil is the blister foil.

The shaping of the profile of the blister is usually achieved by thermoforming. The blister foil usually consists of polyvinylchloride (PVC). The thickness of the blister foil is usually in the range from 0.25 mm to 1.25 mm.

Foils consisting entirely of PVC have a comparatively low level of barrier properties and therefore, for the production of a blister foil, are often coated with polyvinylidene chloride (PVDC) or laminated onto a foil made of polychlorotrifluoroethylene (PCTFE) or of a cycloolefin copolymer (COC).

The sealable foil preferably consists of aluminium or of an aluminium-coated polymer. It has preferably been printed with characters.

It is essential in the invention that the base foil and the outer foil have elements (here termed the outer-foil elements and base-foil elements) that are intended to assume a defined spatial orientation in relation to one another in the foil composite to be produced. It is preferable that there is a repeating, defined distance between the outer-foil elements and/or base-foil elements.

The base-foil elements and the outer-foil elements can by way of example be exterior boundary features of the foil (e.g. corners or edges), markings, characters, punched areas, notched areas, or else can be the blisters of a blister foil. It is moreover not essential that the elements of the base foil match those of the outer foil. It is moreover not essential that the elements are integral constituents of the foil; they can have been applied, attached or introduced, on or in the foil. It is essential that the elements on or in the respective foil have a defined position that can be determined or detected optically. In a preferred embodiment, the base-foil elements are the blisters of a blister foil and the outer-foil elements are characters (e.g. days of the week in abbreviated form).

The outer-foil elements and the base-foil elements are intended to have been positioned in a defined manner in relation to one another in the finished foil composite. If the base-foil elements by way of example are the blisters of a blister foil and the outer-foil elements are characters, the expression “positioned in a defined manner” means by way of example that the characters are centrally positioned over the blisters.

The defined position of the outer-foil elements in relation to the base-foil elements is also termed “intended position”.

In a first step of the process of the invention, at least a portion of the outer foil is placed onto a portion of the base foil.

In particular when material is used in roll form, it is conventional to join the outer foil and the base foil progressively in a continuous process to give a foil composite (until one roll has been consumed). In this type of case, a portion of the outer foil is placed continuously onto a portion of the base foil.

When material in sheet form is used, however, it is also conceivable that the entire sheet of the outer foil is placed onto the entire sheet of the base foil.

Mixed forms are also conceivable. If by way of example the outer foil takes the form of sheets and the base foil takes the form of rolls, the entire outer foil can be placed onto a portion of the base foil.

The intended position can initially be substantially disregarded during this placement procedure.

A device is used to place the foils together. Devices of this type are described inter alia in the prior art described in the introduction. The device is usually the same as that also responsible for the joining of outer foil and base foil. These devices are generally lamination devices of the type described by way of example in Manufacturing Flexible Packaging, 1′ Edition, Elsevier 2014, ISBN: 978-0-323-26436-5 by Thomas Dunn (“Dunn_2015”).

Outer foil and base foil are generally positioned in relation to one another in the device in a manner such that during the joining of the foils the outer-foil elements and base-foil elements are at least approximately in the desired positions in relation to one another. Devices of this type usually have position-adjustment functions which can be used to move the outer foil and the base foil in relation to one another in at least one spatial direction. When material in roll form is used, it is by way of example conceivable that the outer foil can be moved in relation to the base foil (or vice versa) in the direction of running of the foil as it unwinds and/or perpendicularly thereto.

Manual positional adjustment of outer foil in relation to base foil (or vice versa) is time-consuming.

In the invention, there is no need for manual positional adjustment. Outer foil and base foil are fixed in the device in a manner such that at least a portion of the outer foil can be placed onto a portion of the base foil, and the portions placed together are joined by a machine.

The joining of the foils is usually achieved by way of a lamination process, optionally with use of an adhesive. Use or non-use of an adhesive depends mainly on the materials present in the foils that are to be joined. There are materials that can be joined at elevated temperature and under pressure. In the case of other materials, an adhesive is required between the foil portions that are to be joined.

After joining, outer foil and base foil form a coherent entity. Non-destructive separation of the joined foils from one another is usually then impossible.

Further details concerning the joining of foils can be found in “Dunn_2015”.

The result of the joining of outer foil and base foil is a foil composite. Within this, the outer-foil elements are at a measurable position in relation to the base-foil elements. This measurable position is the actual position. Optical recording equipment is used in a following step of the process of the invention to determine this actual position.

The optical recording device is usually a camera which has an image sensor configured for electrical recording of two-dimensional depictions derived from light. It is usual to use a semiconductor-based image sensor which is sensitive to light in the visible region and as far as the middle of the infrared region. Examples of these semiconductor-based image sensors are CCD sensors and CMOS sensors.

Essential factors determining the nature of the optical recording device used are the nature of the elements to be detected from outer foil and/or base foil and the wavelength of the light used for the depiction.

In the usual method, the composite material produced is irradiated with electromagnetic radiation which can be detected by the image sensor, and the radiation reflected and/or scattered by the foil composite is collected by the image sensor. Appropriate camera optics (comprising lenses and/or diaphragms) are used to ensure that a depiction of at least a region of the foil composite produced is obtained on the image sensor.

It is also conceivable that the outer-foil elements and/or the base-foil elements themselves are stimulated to emit electromagnetic radiation, and the radiation emitted from the elements can then be used for a depiction on an image sensor.

It is conceivable by way of example that the outer-foil elements and/or the base-foil elements carry a fluorescent dye which by way of example can be stimulated by ultraviolet light to emit radiation in the visible range.

The resolution of the depiction of the outer-foil elements and/or of the base-foil elements on the image sensor must be sufficiently high to permit matching of the actual position to the intended position within the required error tolerance. This point is explained in more detail at a later stage below.

The usual method involves optical capture of punched-out packaging.

In the depiction it is then possible to discern the position of the outer-foil elements in relation to the base-foil elements (or vice versa). It is not essential here that the outer-foil elements and the base-foil elements are themselves discernible in the depiction; it is sufficient that elements are discernible that permit determination of a definite position of the outer-foil elements in relation to the base-foil elements. This will be explained below on the basis of an example.

For this example it is assumed that the base foil is a blister foil and the outer foil is a sealable foil for the sealing of the depressions of the blister foil. The aim is to produce blister packs in which a print applied on the sealable foil is in a defined position in relation to a depression in the blister foil. The print applied and the depressions are on opposite sides of the blister pack. Conventional camera systems cannot capture the two sides of the blister pack simultaneously in a depiction. However, it is conceivable that the position of the depressions can be determined unambiguously on the basis of the edges of the blister pack (and in this connection see the information provided at a later stage below). However, it is easy to capture the edges of the blister pack (or a portion thereof) together with the print applied on the sealable foil in a single depiction. The depiction therefore does not capture the position of the outer-foil elements (print applied on sealable foil) in relation to the position of the base-foil elements (depressions in the blister foil), but instead captures the position of the outer-foil elements (print applied on sealable foil) in relation to the position of elements (edges of the blister pack) that permit unambiguous determination of the position of the base-foil elements (depressions in the blister foil).

For the use of the edge as reference for the position of elements, the optical recording equipment for the optical detection of the actual position of the outer-foil elements in relation to the position of the base-foil elements in the foil composite typically has an element for accepting and positioning of the blister pack (foil composite or portion thereof) in relation to the optical recording equipment. The positioning of the blister pack into the recording equipment allows the edge of the blister pack to be determined and used as positioned element of the base foil in the step of comparison of the actual position with the intended position. The use of the edge as base-foil element is in particular advantageous when base foil and outer foil are opaque.

We explain briefly below why the position of the depressions in the blister pack can often be unambiguously derived from the position of the edges of the blister pack.

As described above, the production of a blister pack begins with introduction, into the blister foil, of the depressions intended to receive products (e.g. medicament portions). This is preferably achieved by thermoforming: the blister foil is unwound from the roll and passed through a preheating unit. The preheating unit heats the foil, which therefore becomes soft and flexible. The heated foil then passes into a moulding unit where high pressure (from 4 to 8 bar) is used to force the foil into a press mould which forms the depressions in the foil. The foil is then cooled sufficiently to retain the shape imposed by the press mould. The products can then be introduced into the depressions, and the sealable foil can be applied. Individual blister packs are then usually punched out from the foil composite. If the blister packs remain in the press mould during the entire process until the individual blister packs are punched out, they cannot then suffer any slippage at any time in the process, and their position in relation to the edges of the blister pack is dependent only on the location at which the punch makes contact. The punch position is generally defined unambiguously via the punching device. The corners and edges of the punched-out blister pack therefore have an unambiguous position in relation to the depressions (and vice versa), and therefore knowledge of one of these positions permits calculation of the other.

The process of the invention comprises the step of determination of the actual position. As described, this is achieved via optical depiction, on an image sensor, of a portion of the foil composite produced.

The position of outer-foil elements in relation to the position of base-foil elements can then be measured on, or derived from, the image recorded by the image sensor.

It is preferably measured or derived automatically with the aid of image-recognition methods. These methods are extensively described in the literature. The following is merely a small selection: J. P. Marques de Sa, Pattern Recogition, Springer 200, ISBN 3-540-42297-8; V. A. Kovalevsky, Image Pattern Recognition, Springer 1980, ISBN-13: 978-1-4612-6035-6; Ernest L. Hall, Computer Image Processing and Recognition, Academic Press 1979, ISBN 0-12-318850-4; Image Recognition and Classification, edited by Bahram Javidi, Marcel Dekker, Inc., 2002, ISBN: 0-8247-0783-4.

The point that is significant for the present invention is simply that elements in the depictions are recognized and their positions are determined in relation to one another, thus permitting detection of the actual position of the outer-foil elements in relation to the base-foil elements.

Comparison of the actual position with the intended position provides the deviation of the actual position from the intended position. Both actual position and intended position have a tolerance range. When the expression “intended position” is mentioned, it is clear that this does not mean an absolute variable, but instead can only mean a range. The same applies to the actual position. This may be explained by way of an example. Let us assume that there is a marking x on the outer foil. This marking is an outer-foil element. On the base foil, there is a marking □ as base-foil element. We assume that outer foil and/or base foil are/is transparent. The aim is, in the foil composite produced, to place the marking x of the outer foil in a manner such that for an observer viewing the foil composite from a direction perpendicular to the length/width of the foil composite it is centrally within the marking □ of the base foil (intended position). Let us assume moreover that this condition actually exists in the foil composite (actual position=intended position; the deviation being zero). If now the outer foil were to be displaced infinitesimally in relation to the base foil, the image-recognition method would not be able to detect this difference. The main reason for this is that each image sensor has a resolution limit. If the magnitude of the displacement of the outer foil in relation to the base foil is below the resolution limit of the image sensor, the depictions before and after the displacement are regarded by the image sensor and the image-recognition system as identical. Accordingly, the image-recognition system continues to regard the deviation as zero. However, the actual position before the displacement in fact differs from the actual position after displacement. In practice, therefore, the actual position cannot be absolute, but instead is a range. Only when the actual position is outside of this range is it possible in practice to recognize that the actual position has changed. Since, therefore, it is not possible to achieve precise determination of the actual position, it is also not useful to demand a precise (absolute) intended position, absolute compliance with which can never be determined.

The intended position is therefore instead described by data of the following type: the position of the centrepoint of the marking x and the position of the centrepoint of marking □, when observed perpendicularly (in order to avoid any parallax error) are to be at the same location with a tolerance of 0.01 mm in the direction of running of the foils and with a tolerance of 0.01 mm perpendicularly to the direction of running of the foils.

Correspondingly, the actual position is therefore described by data of the following type: the position of the centrepoint of the marking x is the same as the position of the centrepoint of the marking □ with a tolerance of 0.01 mm in the direction of running of the foils and with a tolerance of 0.01 mm perpendicularly to the direction of running of the foils.

The image sensor must accordingly be matched to the required tolerance for the intended position. If the tolerance required is 0.01 mm, the resolution of the image sensor must be correspondingly high, so that it can also detect the actual position with this level of precision.

If, in the context of the prescribed tolerance, the actual position does not correspond to the intended position, a deviation is obtained, which likewise is subject to tolerances.

The deviation can be determined as soon as the positions of outer-foil elements in relation to base-foil elements have been determined.

From the deviation it is then possible to calculate how the outer foil must be moved in relation to the base foil in order that the actual position corresponds to the intended position within the tolerances. The information as to “how the outer foil must be moved in relation to the base foil” can in turn be converted into machine parameters.

All of these calculations are preferably undertaken automatically by one or more appropriate calculation units. It is possible here to use a single calculation unit, which can be a constituent of the optical recording equipment; however, it is also possible to use a variety of calculation units connected to one another by way of communication channels, in order to transfer data that have been determined and calculated.

In a preferred embodiment of the present invention, the optical recording equipment is responsible not only for the automatic recognition of positions of outer-foil elements and base-foil elements but also for the calculation of the deviation of the actual position from the intended position, and the calculation of the corresponding machine parameters. The machine parameters are then transmitted to the device for the joining of outer foil and base foil. In the simplest case, this transmission takes place via a person (user). Once the recording device has calculated the machine parameters, these are displayed on a screen and/or can be stored in a data memory. The user then transfers the displayed machine parameters to the device for the joining of outer foil and base foil, e.g. by manually inputting the same by way of a suitable input device (e.g. keyboard), or connects the data memory to the device and uses appropriate control commands to initiate the transmission of the machine parameters from the data carrier to the device.

However, automatic or semiautomatic transmission of the data from the recording device to the device for the joining of the foils is also conceivable. Transmission of the data can by way of example take place by a wireless method by way of Bluetooth, or via a cable connection, for example by way of a network cable.

In the embodiment described, the device and the optical recording equipment can be separate units not physically connected to one another. It is conceivable that they are operated in different rooms. This type of division of the functions of the system of the invention into separate units can by way of example be advantageous when there is a plurality of devices for the joining of foils, all of which make use of corresponding optical recording equipment. The optical recording equipment is then operated as “stand-alone device”. It is also conceivable that the optical recording device is a mobile device which can be transported as required to a device for the joining of foils.

In another preferred embodiment of the present invention, the optical recording device is an integral constituent of the device for the joining of foils. The image sensor is a component for the entire process: arrangement of the foils, joining, determination of the actual position and of the deviation of the actual position from the intended position, determination of the machine parameters, correction of the arrangement of the foils, and further joining of the foils, where the actual position corresponds to the intended position.

In this embodiment, there can be a calculation and control unit which is responsible for all of the calculations and control operations.

As already explained, the present invention is preferably used for the production of blister packs. This preferred embodiment is explained in somewhat greater detail below, but without any intention of restricting the invention to this embodiment.

In the preferred embodiment mentioned, the base foil is a foil for the production of a blister foil and the outer foil is a sealable foil for the sealing of the blisters of the blister foil. The sealable foil and the foil for the production of the blister foil take the form of rolls. The sealable foil has already been printed. The requirement is to arrange the printed image on the sealable foil in a defined manner in relation to the position of the blisters in the finished blister pack.

The device for the joining of the outer foil and the base foil permits continuous introduction of the blisters into the base foil by means of thermoforming, the charging of medicament portions to the blisters, the lamination of the sealable foil onto the base foil, and the punching-out of blister packs from the laminated foil composite.

The base foil therefore firstly passes through a unit for the introduction of the cavities into the base foil. Medicament portions are then charged to the cavities. The sealable foil is then applied.

In the first step of the process of the invention, the sealable foil is applied substantially without regard to the position of the printed image in relation to the position of the blisters. When a first piece of the foil composite is manufactured, it is very probable that the actual position does not correspond to the intended position.

Blister packs are punched out from the first piece of foil composite. The position of the edges of the blister packs in relation to the position of the blisters has been unambiguously defined.

Once a first piece of foil composite has been produced and blister packs have been punched out from this piece, the continuous process is stopped. It can be stopped either automatically (under machine-control) or by a user.

A blister pack is removed and placed into the optical recording equipment. The optical recording equipment produces a depiction of at least a portion of the blister pack on an image sensor. The digitized depiction is transmitted by the image sensor into a main memory of a calculation unit. A computer programme for image processing, image analysis and image recognition optionally preprocesses the digitized depiction (noise suppression, binarization, edge filtering, or the like) and analyses the digitized and preprocessed depiction in order to determine the position of the printed image (or portions thereof) in relation to the edges of the blister pack.

Once the computer programme has recognized the edges of the blister pack and characteristics of the printed image, it calculates the actual position of the printed image in relation to the position of the blisters (which in turn is obtained from the position of the edges).

The intended position has been stored in a data memory in the optical recording device. A computer programme reads the intended position from the data memory and compares actual position with intended position. It calculates the deviation.

In a data memory in the optical recording device there is an algorithm stored that can translate the calculated deviation into machine parameters. This “translation” is a mathematical depiction: deviation data are converted to machine parameters.

The machine parameters are displayed on a screen of the optical recording equipment.

The machine parameters can be transferred at the touch of a button to the device for the joining of the foils.

The device for the joining of the foils accepts the machine parameters and rearranges the outer foil in relation to the base foil (or vice versa) in a manner such that at all times after start-up of the device and therefore after the continuation of the continuous process the actual position corresponds to the intended position.

The process is continued until one of the rolls (base foil, outer film) has been consumed.

1. Process for production of a foil composite comprising at least one base foil and one outer foil, where the outer foil has elements that are to have a defined intended position in relation to the elements of the base film
where a machine using a device places at least a portion of the outer foil onto a portion of the base foil, and the portions, placed together, of the outer foil and of the base foil are joined to give a foil composite,
wherein-an actual position is obtained by using optical recording equipment to determine the position of the outer-foil elements in relation to the base foil elements in the foil composite,
the actual position is compared with the intended position in order to determine the deviation of the actual position from the intended position,
machine parameters are determined on the basis of the deviation of the actual position from the intended position,
the machine parameters are transferred to the device, and
the device accepts the machine parameters and thus adjusts the positions of the outer foil and of the base foil in relation to one another in a manner such that during the further joining of outer foil and base foil the position of the outer-foil elements in relation to the base-foil elements corresponds to the intended position.

2. Process according to claim 1, where the optical recording equipment determines the actual position in the form of a depiction at least of a region of the foil composite produced.

3. Process according to claim 2, where the intended position has been stored in the form of a depiction at least of a region of the foil composite produced, and the actual position is the depiction at least of that region of the foil composite produced that has been stored for the definition of the intended position.

4. Process according to claim 1, where the base foil is provided by a blister foil wherein, introduced into the blister foil, there are depressions intended to receive products, and where the outer foil is a sealable foil which seals the depressions in the blister foil.

5. Process according to claim 1, where the outer-foil elements are a printed image, and optionally comprise characters.

6. Process according to claim 4, where the base-foil elements are the depressions of the blister foil.

7. Process according to claim 1, where the base-foil elements are the edge of the foil composite.

8. Process according to claim 1, where the base foil and/or the outer foil are/is present in the form of roll(s).

9. Process according to claim 1, where the outer foil and the base foil are joined in a semicontinuous lamination process with or without use of an adhesive, where the semicontinuous lamination process comprises firstly a portion of the foils is joined to give a foil composite, the lamination process is interrupted in order to use the optical recording equipment to determine the actual position in the foil composite, and the process is restarted after the device has adjusted the position of the outer foil and the base foil in relation to one another on the basis of the transmitted machine parameters.

10. Process for production of blister packs comprising
a blister foil into which depressions have been introduced,
medicament portions in the depressions of the blister foil, and
a sealable foil for sealing the depressions, where the sealable foil has a printed image that is to assume a defined intended position in relation to the depressions of the blister foil or in relation to an edge of the blister pack,
wherein the process comprises the following:
introduction of the medicament portions into the depressions of the blister foil,
using a device for the joining of foils to seal, with the sealable foil, a portion of the blister foil, whereupon a foil composite is produced,
punching-out of a blister pack from the foil composite,
using optical recording equipment to determine the actual position of the printed image in relation to the depressions of the blister foil or in relation to the edge of the blister pack, where the optical recording device optionally exists as separator unit independently of the device for the joining of foils,
determination of the deviation of the actual position from the intended position,
determination of machine parameters on the basis of the deviation of the actual position from the intended position, where the machine parameters provide information as to how the sealable foil and the blister foil must be arranged in relation to one another in order that the actual position corresponds to the intended position,
transfer of the machine parameters to the device for the joining of foils,
using the machine parameters for adjustment of the positions of the sealable foil and the blister foil in relation to one another,
further sealing of the blister foil with the sealable foil, optionally in a continuous process, thus producing a foil composite in which the actual position of the printed image in relation to the depressions of the blister foil or in relation to the edge of the blister pack corresponds to the intended position.

11. System comprising
an outer foil which comprises outer-foil elements,
a base foil which comprises base-foil elements,
a device for the joining at least of a portion of the outer foil to a portion of the base foil to give a foil composite in a manner such that the outer-foil elements in the foil composite are present in a defined intended position in relation to the base-foil elements, and optical recording equipment for the optical detection of the actual position of the outer-foil elements in relation to the position of the base-foil elements in the foil composite, where detection capability covers at least that region of the produced foil composite that has been stored for the definition of the intended position,
a calculation unit for the determination of the deviation of actual position from intended position a calculation unit for the determination of machine parameters based on the deviation of actual position from intended position, where the machine parameters provide information as to how the device must arrange the outer foil and the base foil in relation to one another in order that the actual position corresponds to the intended position.

12. System according to claim 11, where the base foil and/or the outer foil are/is present the form of roll(s).

13. System according to claim 11 or 12, where the base foil is provided by a blister foil wherein, introduced into the blister foil, there are depressions intended to receive products, and where the outer foil is a sealable foil which seals the depressions in the blister foil.

14. System according to claim 11, where the outer-foil elements are a printed image, optionally characters, and where the base-foil elements are the depressions of the blister foil or the edge of the foil composite.

15. System according to claim 9, where the optical recording device exists in the form of a separate unit independently of the device for the joining of foils.
